(19) United States
(12) Patent Application Publication
(10) Pub. No.: US 2022/0250126 A1
(43) Pub. Date: Aug. 11, 2022

(54) SYSTEM AND METHOD OF REMEDIATING INDUSTRIAL, TAILINGS, AND/OR FRACKING SOIL

(71) Applicant: Tal Brammer, Kirkland, WA (US)

(72) Inventor: Tal Brammer, Kirkland, WA (US)

(21) Appl. No.: 17/171,674

(22) Filed: Feb. 9, 2021

(51) Int. Cl. B09B 3/00; C04B 28/02; C04B 14/28; C04B 18/16; C04B 18/08

(52) U.S. Cl. CPC B09B 3/0041; C04B 28/02; C04B 2111/00784; C04B 18/162; C04B 18/08; C04B 14/28

(57) ABSTRACT

A system and method of remediating an industrial, tailing, or fracking soil mass comprising the steps of analyzing a sample of at least one of the industrial, tailing, and fracking soil mass; wetting a predetermined volume of the industrial, tailing, or fracking soil mass with water to a predetermined minimum percentage of moisture content; spreading at least one of an inorganic polymer and stabilizing additive to the predetermined volume of industrial, tailing, or fracking soil mass; compressing the predetermined of industrial, tailing, or fracking soil mass under a predetermined load; spreading or spraying a polymerizing top sealer onto the predetermined of industrial, tailing, or fracking soil mass at a predetermined rate based upon a target soil mass and toxic content; and compressing or vibrating said treated and sealed predetermined of industrial, tailing, or fracking soil mass for compaction at a predetermined load.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Soil stabilization has common applications in the construction industry and resource management, such as in producing construction and industrial materials and structures like concrete and bricks; in flood control such as levees, ditches, irrigation systems, berms, trenches and other detention barriers. Other exemplary applications for soil stabilization are in containment and handling of waste streams and related runoff, contaminants, or any materials detrimental to the environment, such as with landfills, oil sands, sewage and water treatment facility waste, or tailings from industrial processes such as mining, smelting, and metal milling Tailings are the materials left over after the process of separating the valuable fraction from the uneconomic fraction of an ore. Tailings are waste rock or other material that overlies an ore or mineral body and is displaced during mining without being processed. Common issues in soil stabilization include structural integrity and containment, particularly where containment involves contaminants or hazardous materials in leachates or carrier fluids, including but not limited to airborne fluids, muds, dusts, RCRA 8 metals, and other otherwise mobile particulates.

Following are examples in the prior art that, while expected to be helpful to further educate the reader as to additional aspects of the prior art, are not to be construed as limiting the present invention, or any embodiments thereof, to anything stated or implied therein or inferred thereupon.

United States Patent Application Publication 20090003939 discloses a material composition using mainly yellow soil for molding structures for construction, such as to produce bricks and the like. The material composition for construction includes yellow soil, decomposed granite soil, a small amount of cement serving as a water-curing material, a solidifying agent, acrylic monomers for improving the compactness of tissue to impart water proofing and strength, and functional powder. In conventional technologies, among construction structures using mainly yellow soil, calcined yellow soil brick is high in quality, the yellow soil brick being manufactured by drying yellow soil in several stages to increase quality, mechanically vibrating the dried yellow soil, compression molding the vibrated yellow soil, and then calcining the molded yellow soil at high temperature. A construction material using mainly yellow soil is disclosed, by which the amount of harmful materials generated from cement can be decreased because yellow soil has specific advantageous characteristics, and a small amount of cement is used. The deterioration of physical properties due to insufficient hydration can be reinforced through solidification because a small amount of cement is used. Hydrophobic characteristics, flexural strength, tensile strength and shear strength of buildings can be improved because tissue becomes compact due to the addition of acrylic monomers. An embodiment describes a material composition comprising: 50 wt % of yellow soil; 30 wt % of decomposed granite soil; 10 wt % of white cement, 3.5 wt % of liquid acrylic monomer containing a cross-linking agent; 2.5 wt % of a Solidifying agent; 1.5 wt % of illite; 1.5 wt % of monazite powder; and 1.0 wt % of an admixing agent. Specific construction materials are produced using the material composition via a combination of a water-curing method through the hydration of cement, a solidification method using a solidifying agent, and a curing method through a cross-linking process using acrylic monomer containing a cross-linking agent.

U.S. Pat. No. 9,328,216B2 relates to improved clayey barriers, such as compacted clay liners or geosynthetic clay liners, which can be used, among other uses, to isolate waste liquids from the environment. It relates to clay which is treated with an anionic polymer and is subsequently dehydrated before it is used as a barrier. The improved clays are surprisingly well, and for a long term, protected from chemical attack by aggressive electrolyte solutions present in, for example, sea water or waste liquids. Described is use of a composition as a hydraulic clayey barrier wherein said composition is obtainable by a) mixing a dry clay with an anionic polymer solution to obtain a slurry of clay treated with an anionic polymer, and b) dehydrating said clay treated with an an polymer. The engineered clay comprises clay such as bentonite and an anionic polymer such as sodium carboxymethyl cellulose that results in a dispersed clay structure having a decreased hydraulic conductivity and a service life up to 10,000 days or more.

United States Patent Application 20030070589 discloses a soil stabilization composition for enhancing compaction and reducing permeability of different types of soil. The composition includes an acrylic copolymer resin, an enzyme, and portland cement. Proportions of resin enzyme and cement vary in accordance with the type of soil being treated. The composition is applicable in unimproved earth surfaces, such as dirt roads, parking lots, reservoir surfaces, and elsewhere. It may enhance structural integrity while lowering permeability, to levels compatible with those of road surfaces.

Lime-reinforced soil is a building material with a long history, its mechanical properties have been previously explored. Based on the unconfined compressive strength and splitting strength of lime soil, the Mohr-Coulomb destruction envelope curve of lime soil was investigated by Consoli using lime content and porosity as basic parameters. A series of studies were conducted by Wang, including size effect on cementitious aggregates during curing of calcined soil including thermal conductivity, suction, and microstructural changes during curing, and the effect of aggregate size on the compressibility and air permeability of lime-treated fine-grained soils. Jha studied the volume change behavior and strength growth mechanism of lime-treated gypseous soil from the perspective of mineralogy and microstructure. The short-term effects of the physical properties of lime-treated kaolin were studied by Vitale. The aforementioned findings indicated that lime could fill the pores between soil particles to a certain extent and react with the active silica and other components in the soil to improve their mechanical properties.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an ASTM C 642 absorptive properties comparison between Pro-SealECCO NanoCreteCH01NC and CL02NC and Portland cement CH01PC and CL02PC, in accordance with an embodiment of the present invention.

FIG. 2 shows a comparison of Portland cement additive to Pro-SealECCO XWCrete CH01XW and CH02XW additive for wet soil compositions, in compared to Portland cement CH03PC and CL04PCin accordance with an embodiment of the present invention.

FIG. 3 shows the anionic process at the Novel Properties level allowed by Nano and sub-Nano sized particles which allows for the stacking of negative ions in a variety of patterns and structures unavailable to the compared weaker Van der Waal Forces reactions, in accordance with an embodiment of the present invention.

FIG. 4 shows ASTM C39/ASSHTO T89 compressive strength test results, in accordance with an embodiment of the present invention.

FIG. 5 shows ASTM C39/ASSHTO T89 Compressive Strength test results, in accordance with an embodiment of the present invention.

FIG. 6 through FIG. 10, shows, in accordance with an embodiment of the present invention, a comparison of the differences in leachate containment for geopolymers, Portland cement and nano meso inorganic polymers as additives.

FIG. 11 shows an illustration of Atterberg limits, in accordance with an embodiment of the present invention.

FIG. 12 shows Atterberg limits results, in accordance with an embodiment of the present invention.

FIG. 13 shows CBR results dry soils, in accordance with an embodiment of the present invention.

FIG. 14 shows CBR results, in accordance with an embodiment of the present invention.

FIG. 15 shows a table of a seventy-two-month comparative submersion test and image of the still intact Nano meso inorganic polymer treated tailings soils, in accordance with an embodiment of the present invention.

FIG. 16 illustrates a flowchart detailing an exemplary method 1600 of remediating or stabilizing tailing or fracking soil, in accordance with an embodiment of the present invention; and

FIG. 17 illustrates a flowchart detailing an exemplary method 1700 of remediating or stabilizing tailing or fracking soil, in accordance with an embodiment of the present invention.

Unless otherwise indicated, illustrations in the figures are not necessarily drawn to scale.

### DETAILED DESCRIPTION OF SOME EMBODIMENTS

The present invention is best understood by reference to the description and any figures set forth herein.

Embodiments of the invention are discussed below with reference to any Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limit the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envision some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude, e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reasons, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of a remediating or stabilization additive (or “additive”) as described herein may comprise one or more base materials comprising cement, one or more anionic materials, one or more barrier components, one or more polymers, one or more minerals, one or more metals, and one or more mineral salts. Each of the base material, anionic material, barrier component, polymer, mineral, metal, and mineral salt may comprise zero to ninety-five percent of the additive. The additive may include but not a limitation, powder Nano meso inorganic polymer, semi solid meso inorganic polymer, liquid meso organic/inorganic polymer, etc. The additive may be environmentally friendly and may contain no volatile organic compounds (VOCs). The precise composition may be tailored for each application via characterization of a soil and then modulating the proportions of the base material, anionic material, barrier component, mineral, metal, and mineral salt in the additive in order to effect a substantially hydrophobic character and a compressive strength of at least one hundred pounds per square inch on a composite comprising the soil and stabilization additive.

Anionic materials, in combination with other additives to be combined with the soil, may create an anionic mass with hydrophobic properties which may add to the overall stability of the mass. Because the mass may be hydrophobic, water may be prevented from penetrating or breaking down into the mass. Additionally, the compressive strength of the mass may increase based on the percent by volume or weight of additives to be added to the soil.

The words stable, stabilize, stabilizing, stabilization, and the like, may be used somewhat interchangeably with similar effect. Likewise, stabilization may refer to and/or include either structural, chemical, mechanical, magnetic, or other stabilization properties of the character of a soil, ash, or other earthen or inorganic mass as defined herein, or of a resulting composite, as defined herein.

Each of the base additive material: anionic material, barrier component, polymer binder, mineral, metal, and mineral salt may be available as a single component or as a multi-component mixture in any number of combinations and proportions. Exemplary components may include talc, nano talc, soda ash, miso inorganic Nano anionic materials, asphalt foams, Nano meso organic, meso organic, Nano barrier additives, meso inorganic binder additives, calcium, semi-liquid vitreous-form base integrated with Nano meso inorganic, meso inorganic, Nano anionic materials, Nano silica additives, lime, Portland cements, lime mix, kiln dust, vitreous-form additives, semi-solids, fly ash, and semi-liquid base integrated with meso organic Nano barrier additives. The particle size of the inorganic powders and semisolids combined in Nano scale, may create greater surface area for reactivity, thus the isomers may have far more reactivity potential. In part, this reactivity potential creates many more stereoisomers forming meso compounds, ligands by three characteristics: ionic reactive formations, coordinated formations, and linked formations. These are the foundation of the Novel Properties peculiar to scaled Nano meso inorganic polymerization.

Some examples of commercially available products comprising some or all of the base material, anionic material, barrier component, polymer, mineral, metal, and mineral salt may include NanoCrete™, XXWCrete™, BedR.O.C.™, TopR.O.C.™, Pro-SealECCO™, Holnam™, Pennsylvania Quarts™, Dupont™, Portland Cements™, Five Star, and etc. As will be understood by one skilled in the art, each of the commercially available products listed above may also include subsidiaries, resellers, private labelers, etc. of the commercially available products, and may not be limited to the commercially available products themselves.

The additives described herein may be applicable to wet and dry soils or earthen masses. In addition to relatively dry soil, “soil” for purposes of the additives and their applications, improvements, and benefits described herein may include liquids with suspended solids, such as, but not limited to, slurries and liquefied soils, heterogeneous or homogeneous solutions, sediments, silts, etc. Examples of relevant soils may include, are not limited to, soils associated with tailings from industrial operations such as mining or smelting, cement manufacturers, fly ash, silicate manufacturers, water based polymer manufacturers, contaminated retention ponds and related semi-solid and saturated and contaminated sediments, silts, sludge, fracking waste and runoff, brownfields, construction sites, railroad beds, road beds, waste water evaporation ponds, landfills, reservoir bases, slope slide control, storm drain control and canals, gardening, garden paths, park trails, and in remediation. Further, the additives may be applicable to any soil type as classified by the United States Department of Geology. As will be understood by those skilled in the art, examples of such soil types may be identified by the following Unified Group Soil Symbols: GW, GP, GM, GC, SW, SP, SM, SC, ML, CL, OL, MH, CH, OH, PT. These may include wet or dry soils having varying moisture content, such as but not limited to, those having less than twenty, sixteen, ten, or five percent moisture content, or those having greater than sixteen, twenty, thirty, forty, fifty, sixty, seventy, or eighty percent moisture content.

Soils and earthen masses including, but not limited to, mine tailings, waste management, fly ash waste, and oil sands may become hyper saturated with water or other fluids. The hyper-saturation may create a state of being in the soil known as liquifaxing (fluid like soil). The soil may weaken berm barrier structures, cake stakes and other storage forms of compressed soils (tailings) to failure. In the fluidized state or in the current stabilization process state the toxic soils may leach out through osmotic transfers, water passing through compacted soil/tailings, drawing out or leaching toxins to the ground and/or ground water contaminating the ground, ground water, and the greater extended bio habitat. In an embodiment, the system may super-stabilize the soils/tailings (all types) and may bind in the toxins while realigning the ions to create an anionic mass that is now hydrophobic with anti-leaching properties.

An embodiment of a composite as described herein may comprise soil and a stabilization additive. NanoCrete and/or XWCretes (powders) plus BedR.O.C. (semi solid) and TopR.O.C. (fluid) create the bulk of the stabilization additive(s). These materials may be introduced to the target soils via, for example, without limitation, manual labor, pump, dump, spreader, spray, gravity flow or any practical known mechanical means and subsequently tilled into the target soils using, for example, without limitation, tillers, reclaimers, or other such mechanical or manual means, historically or currently available or such delivery system technology that may become available in the future, in such a fashion as to thoroughly induce and mix the target soils with the additives. In such a composite, the stabilization additive may comprise less than fifty weight percent of the composite. Alternatively, the stabilization additive may comprise less than forty weight percent, less than thirty weight percent, less than twenty weight percent, less than ten weight percent, less than five weight percent, less than four weight percent, less than three weight percent, less than two weight percent, or less than one weight percent of the composite and in very rare cases greater than fifty weight percent of the target mass. The ratios or percent to weight or volume of each of the components of any given containment and stabilizing additive mix of this technology may depend upon the soil type and contaminant content of soil or earthen masses, desired type of containment, for what period of time the mass is to be stabilized and contained and use of mass post stabilization and containment as system may or may not be designed and customized to these aforementioned and other site identifiers.

Another embodiment of the composite described herein may comprise soil, a stabilization additive, and a sealer. Examples of commercially available sealers may include the Pro-Seal ECCO TopR.O.C product by Pro-Seal Products, Inc. to include but not limited to, acrylics, urethanes, polysulfides, polymerics, methyl methacrylate and other sealers by, but not limited to, Dow, Dow Corning, Carlyle, ProSoCo, or any such polymer-based sealers by any manufacturer, private labeler, or reseller used in the art.

Another embodiment of the composite described herein may comprise a soil contaminated with a material subject to regulation under environmental law, a stabilization additive comprising one or more base materials including but not limited to cement, and one or more anionic materials NanoCrete and/or XWCretes combined with BedR.O.C., a substantially hydrophobic character, a compressive strength from at least about one hundred pounds per square inch to more than three thousand pounds per square inch, etc.

The present invention will now be described in detail with reference to embodiments thereof as illustrated in the accompanying drawings.

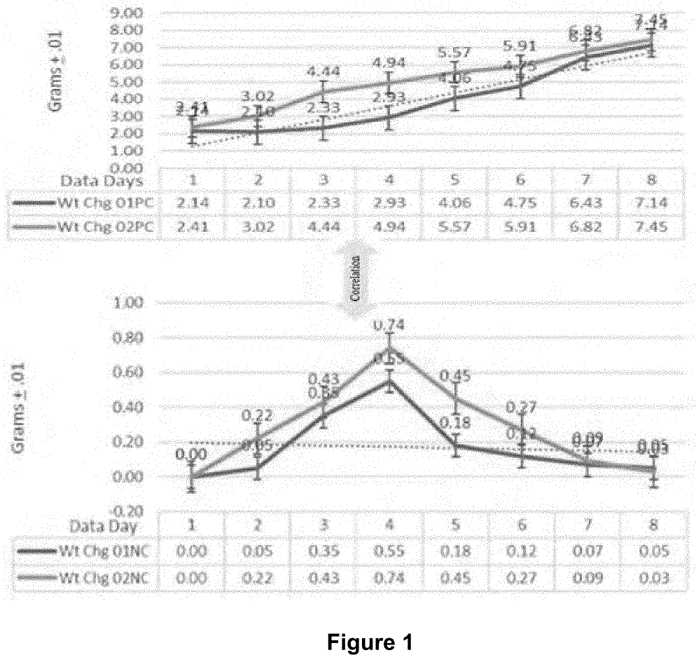

FIG. 1 shows an ASTM C 649 absorptive properties comparison between Pro-SealECCO XWCrete 01XW and 02XW and Portland cement 01PC and 02PC, in accordance with an embodiment of the present invention. A proximately 5% additive was used which is less than the ideal additive range of about 18 to 26%. Portland cement is shown to be absorptive and XWCrete is shown to be hydrophobic/anionic.

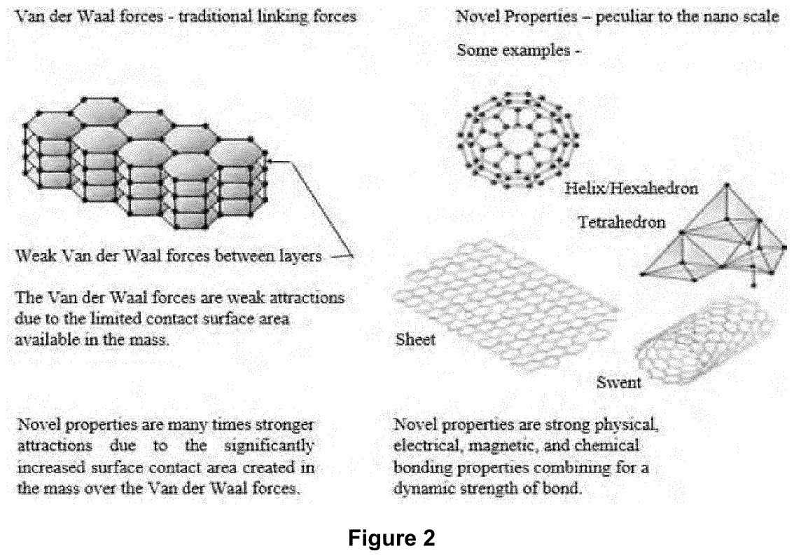

FIG. 2 shows the anionic process at the Novel Properties level allowed by Nano and sub-Nano sized particles which allows for the stacking of negative ions in a variety of patterns and structures unavailable to the weaker Novel Properties, in accordance with an embodiment of the present invention. The Novel Properties peculiar to the Nano scale are demonstrated when we compare Portland cement as a stabilization additive to Pro-SealECCO NanoCrete as an additive for dry tailing soil and/or soil compositions. The results underscore the scale and properties values relating to hydrophobic and anionic behaviors of NanoCrete.

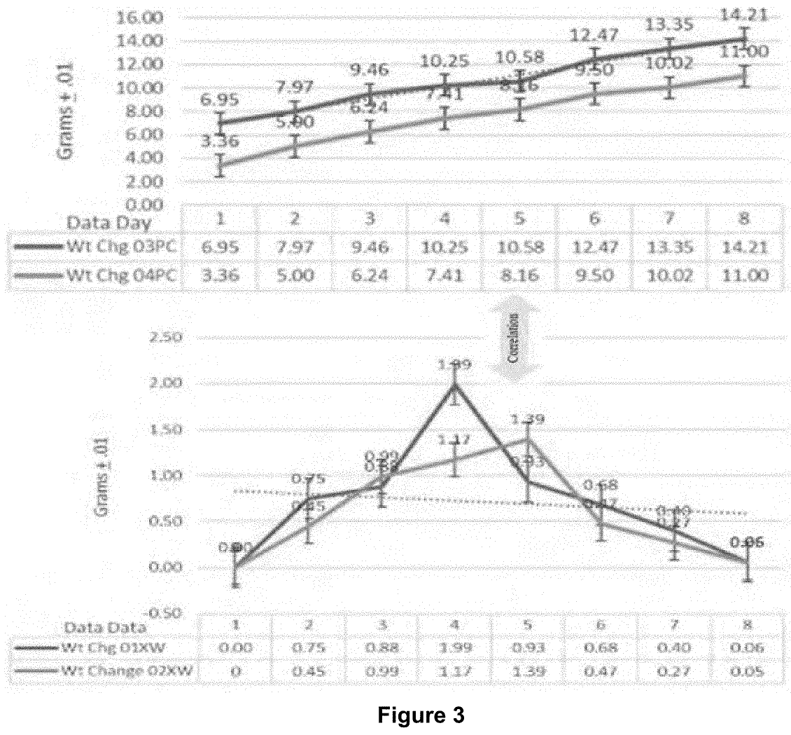

FIG. 3 shows a comparison of Portland cement additive to Pro-SealECCO XWCrete additive for wet soil compositions, in accordance with an embodiment of the present invention. The additive used is about 6% which is less than the ideal additive range of about 18 to 26%.

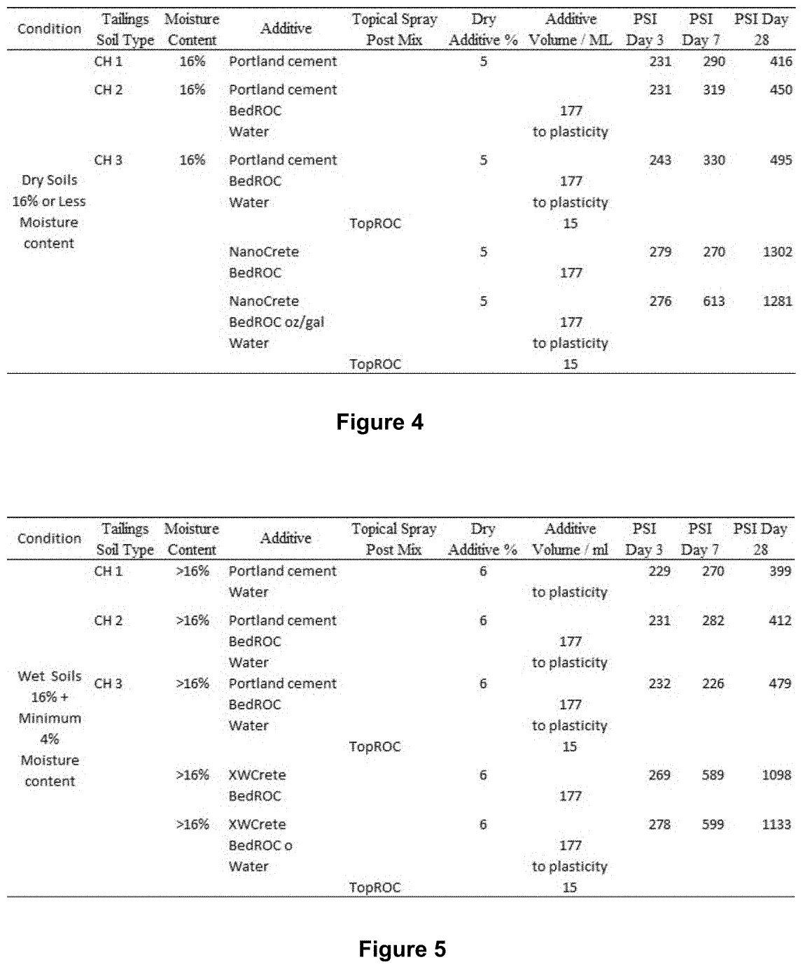

FIG. 4 shows ASTM C39/ASSHTO T89 compressive strength test results, in accordance with an embodiment of the present invention, comparing Portland cement additive to Pro-SealECCO NanoCrete Nano meso inorganic polymer compound additive for dry tailing soils.

FIG. 5 shows ASTM C39/ASSHTO T89 Compressive Strength test results, in accordance with an embodiment of the present invention, comparing Portland cement additive to Pro-SealECCO XWCrete Nano meso inorganic polymer compound additive for wet tailing soils.

In certain embodiments, the composite of additive and soil may feature a compressive strength of at least two hundred pounds per square inch (psi) after three days, at least five hundred psi after seven days, and at least one thousand psi after twenty-eight days, etc. Pounds per square inch may be measured according to The American Society for Testing and Materials (ASTM) Standard Test Method C39, modified. As will be appreciated by one skilled in the art, the percent of each additive may be dependent upon factors such as, but not limited to, soil make up, contaminant content, etc. as shown in FIGS. 4 and 5.

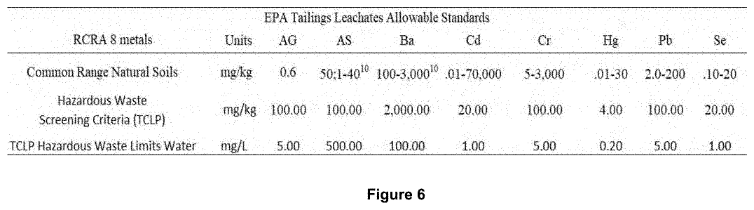

In FIG. 5 and FIG. 6, both Pro-Seal ECCO NanoCrete and Pro-SealECCO XWCrete compound are compared to Portland cement compressive strengths with correlating percentages of additives to mass. Portland cement falls short of the compressive strengths of the NanoCrete and XWCrete and is hydrophobic/anionic. The Anionic process and the Novel Properties allowed by Nano and sub-Nano sized level of particles. Nano and sub-Nano particles allow for a finer screen line of particles. This may allow tighter compaction of mass, increasing density and removing spaces between particles, as well as the stacking of negative ions and previously mentioned herein. The mass is tighter and denser, therefore has greater resistance to compression, thus the higher compression strength properties the anionic/hydrophobic behavior disallow osmotic flow of water into mass.

In some embodiment, additives may be added to soil to stabilize and bind with hazardous materials such as, without limitation, EPA, RCRA 8 metals, other leachates, tailings, etc. such that the hazardous materials may be prevented from leaching into the ground, ground water, or air and causing harm to the environment. As such, the additives may be used to remediate soil that may have been damaged as a result of, for example, without limitation and not limited to, fracking, mining, dirty power generation i.e., coal power, landfill, etc.

FIG. 6 through FIG. 10, shows, in accordance with an embodiment of the present invention, a comparison of the differences in leachate containment for geopolymers, Portland cement and Nano meso inorganic polymers as additives. In instances when the Nano inorganic polymer formulation may be designed specifically to a site, the stabilization and containment Nano meso inorganic polymer material may be formulated to all known soil types as described here in the body of this document. The formulation of the system is, though not always required to be formulated to, but not limited to, specific site climatic cyclic conditions, soil type, chemical contents, and soil contaminants. The formula may or may not be affected by type of contaminant and percent of containment, soil moisture content, soil pH, and other natural or industrial influences at a given site. In such cases, as are influenced by these and other factors, a soil analysis is performed when required, the data analyzed, and the formulation is designed incorporating this data to create proper chemical, electrical, magnetic, ionic, and other Novel Properties reactions and behaviors to maximize performance under the given site conditions and site criteria. The ranges of percent additive as have been represented herein this document express these varying kinds of influences as exampled. Peculiar to the RCRA 8 metals and other contaminant bodies in the earthen mass, it is important to understand the relationships of those reactive bodies to create appropriate and functional chemical, magnetic, electrical, ionic and other Novel Properties reactions and behaviors to gain the final desired result. Anyone skilled in the art will understand the complex relationships of reactivity through ion exchange, coordination, ionization, isomer structuring, and linkage in a given mass to generate Stereoisomers, CIS isomers, Trans isomers, Optical isomers and other chemical behaviors enabling the development of appropriate desired binding bond integrity and anionic/hydrophobic properties.

FIG. 6 shows an EPA published allowable levels standards for RCRA 8 metals including Ag (silver), As (arsenic), Ba (barium), Cd (cadmium), Cr (chromium), Hg (mercury), Pb (lead), and Se (selenium).

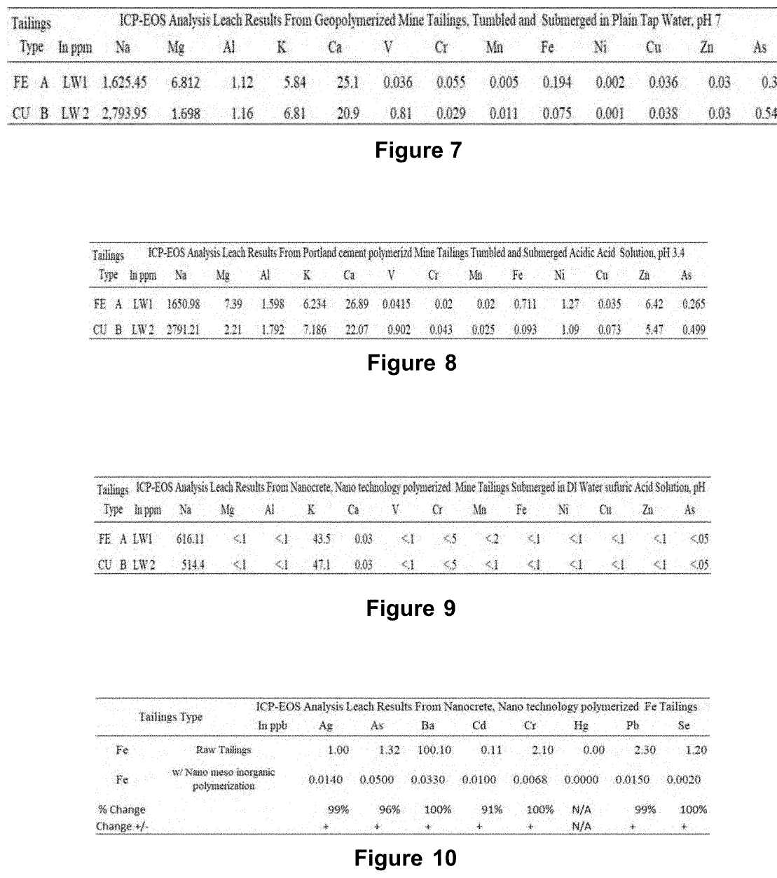

FIG. 7 shows, in ppm, Geopolymer additive EPA TCLP modified test results (leached in plain tap water pH7), composition >50% geopolymer to <50% tailings tailing's soil volume.

FIG. 8 shows, in ppm, Portland cement additive EPA TCLP test standard, DI water acetic acid solution pH3.7) composition about 50% geopolymer to <50% tailings tailing's soil volume.

FIG. 9 shows, in ppm, Nano meso inorganic polymer additive EPA TCLP modified test results (increased period 30 days, draw every 24 hours, sulfuric acid solution pH3.0) composition about 22% geopolymer to about 78% tailings tailing's soil volume. This is far below the preferred mix range of about 505 to 75% in this environment.

FIG. 10 shows RCRA 8 Result ppb Nano meso inorganic polymer additive EPA TCLP modified test (as ppm test). composition about 22% geopolymer to about 78% tailing's soil volume. This is far below the preferred mix range of 50% to 75% in this environment.

FIGS. 6 through 10 further demonstrate the peculiar properties of the nanoscale in that the leachate binding properties of nano meso inorganic polymerization of leachates is related to the particle sizes of the mass at or below Nano particle sizes of about one billionth of a meter cubed (1.0b m³) or smaller. This screen line allows for thousands of times more surface area access affording many more chemical, magnetic, electrical, ionic and other Novel Properties reactions and behaviors such as, but not limited to, stereoisomer, CIS isomers, Trans isomers, Optical isomers and other chemical behaviors ligands, connectors, links, and anionization and ionization architecture of mass. This behavior increases the bond strength to the leachates, substantially disallowing separation of lactates from mass.

The baseline of the Nano meso inorganic polymer construction is normally, but not always, the finest portion of the screen line at Nano or sub-Nano particle sizes. The creation of the compound based upon tailing soils or soils content of metals and other toxins is, but not always, a factor in the properties of any certain soils additive mix.

One example of an additive combined with a soil having approximately sixteen percent moisture content may comprise, but not limited to, a Nano meso inorganic polymer compound, fly ash, and/or lime. The additive may comprise between two and twenty weight percent, or between one and fifty volume percent of the composite formed by the additive and soil. The composite may display a compressive strength greater than one thousand psi after twenty-eight days.

All compounded formulations may express anionic hydrophobic properties.

Another example of an additive combined with a soil having approximately sixteen percent moisture content may comprise, but not limited to, Nano meso inorganic polymer compound, kiln dust, and/or lime. The additive may comprise between two and twenty weight percent, or between one and fifty volume percent of the composite formed by the additive and soil. The composite may display a compressive strength greater than one thousand psi after about twenty-eight days.

Geopolymers such as ground granite lime and other slakes, may be made from, but not limited to, ground limestone rock, which naturally contains calcium carbonate and magnesium carbonate. Lime may be added to soil, to increase the soil's pH, making the soil less acidic and more alkaline. Lime-cement may be used as a stabilizing binder to treat the soil. For example, strength or stabilizing characteristics. These mixes/additives maintain no sustainable anti leaching qualities.

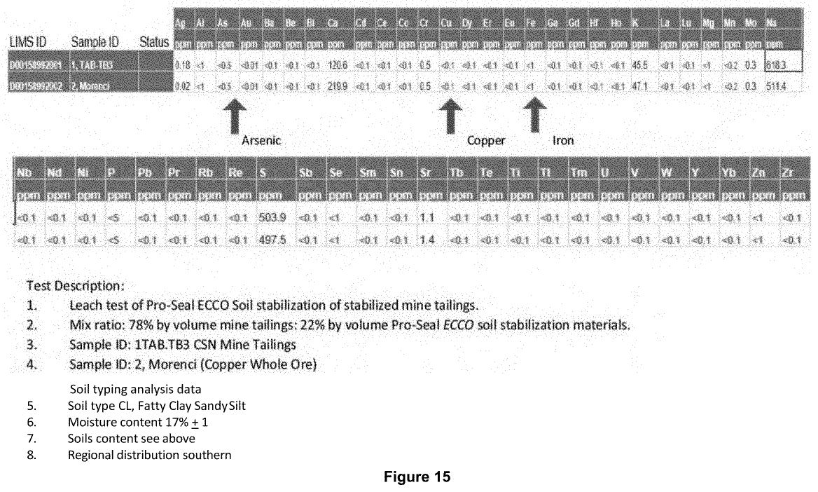

An environmental impact of the Nano meso inorganic polymer, Soil-Mine Tailings Binder Mix, in berm construction was evaluated using a series of laboratory tests. Results of the geotechnical tests showed that the properties of the soil sample improved with the addition of mine tailings and binder. There was an increase in the maximum dry density with a decrease in the optimum moisture content and the soil gained water repellency. There was also an increase in the strength of the lateritic soil, this was evident from the California Bearing Ratio (CBR) and the unconfined compressive strength values. The environmental performance evaluation was determined by the Leaching test (see FIG. 15), conducted by the University of Arizona, on the Soil-Mine Tailings sample with the Nano meso inorganic polymer additives, to determine the capability of the binder in retaining heavy metals. The results of the leaching test show that the binder was able to reduce the heavy metals in the leachate below the regulatory level, with the exception of mercury (not yet tested). Mineralogical analysis done on the leached samples revealed that the binder was able to immobilize the mine tailing minerals that could adversely affect the environment in the soil matrix.

Another example of an additive combined with a tailings soil having greater than approximately sixteen percent moisture content comprises the following: XXWCrete, BedR.O.C., and include fly ash and lime. The additive may comprise between two and twenty weight percent, or between one and fifty volume percent of the composite formed by the additive and soil. The composite displays a compressive strength greater than eight hundred psi after twenty-eight days and contains toxic leachates.

Fly ash may be used as prime material in many cement-based products, such as poured concrete, concrete block, and brick. For example, one of the most common uses of fly ash is in Portland cement concrete pavement or PCC pavement. Road construction projects using PCC may use a great deal of concrete and substituting fly ash provides significant economic benefits. Fly ash may be used as embankment and mine fill, and it has increasingly gained acceptance by the Federal Highway Administration. Fly ash may be used as a ‘chemical liner’ beneath the tailings, applying fly ash as both a cap and bottom liner, or blending fly ash with tailings may produce significantly less acidity, salinity, and metal leaching than using the fly ash as a cap. The capacity of fly ash to control acid generation may be attributed to its acid neutralizing capacity and high pH. Further the CBR (California Bearing Ratio) and Atterberg Plasticity and shrinkage properties factor into any earthen roadway or vehicular access. These mixes/additives will not maintain sustainable anti leaching qualities.

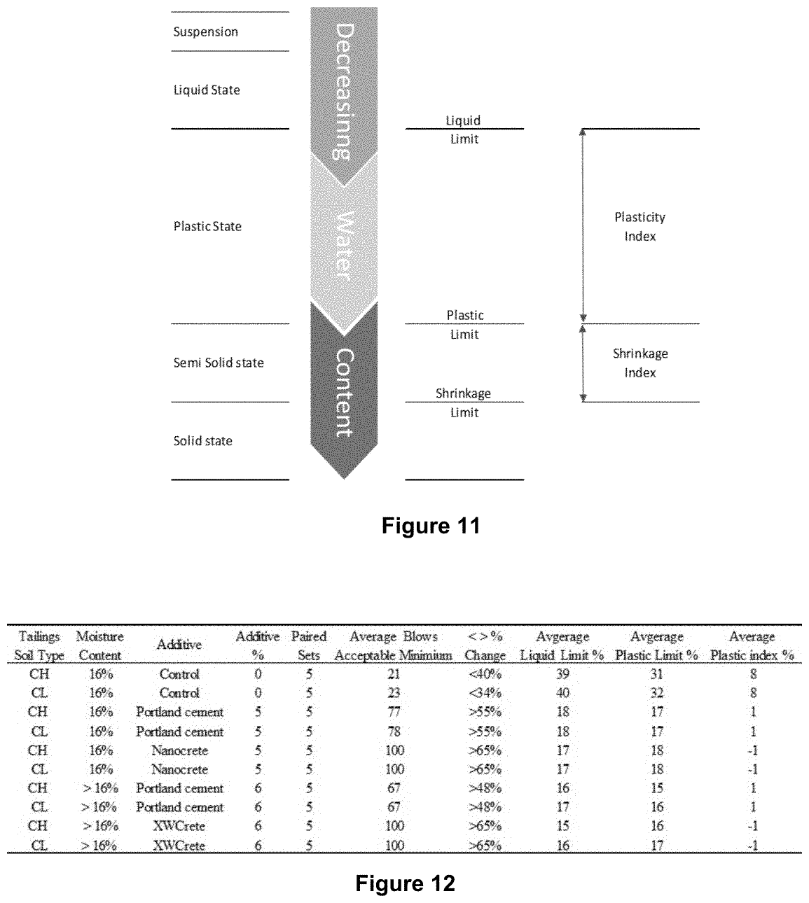

FIG. 11 shows an illustration of Atterberg limits, in accordance with an embodiment of the present invention.

FIG. 12 shows Atterberg limits results, in accordance with an embodiment of the present invention, comparing Nano meso inorganic polymers to Portland cement. As shown, Portland cement expands thus allowing cracking and ultimate failure especially due to its ability to accept and take on water, increasing both mass and weight of an earthen structure. The following examples of CH and CL soil mixes are for demonstration purposes only. These soil types are for modeling demonstration purposes only. None of the known soil types as describe in the body of this document present limitations or exceptions to Nano meso inorganic stabilization containment technology presented for patent. All meso inorganic and Nano meso inorganic polymer system formulations are designed to a given soils actual make up, moisture content and mineral and/or organic content.

The CH and CL soil types, in tables, are for modeling demonstration purposes only. All meso inorganic and Nano meso inorganic polymer system formulations are designed to a given soils actual make up, moisture content and mineral and/or organic content.

In an embodiment, an example of an additive combined with a CH type soil with a differentiating mineral and/or organic content, having approximately sixteen percent moisture content may comprise the following: soil about 93% to 99% by volume: additives Nano meso inorganic polymer compound, about 1%-7%, Nano meso inorganic semi solid polymer approximately 3.8 liters per cubic meter infused into soil, compressed and finished with Nano meso organic surface penetrating polymer at a rate of about 4.8 liters per 40 meters square. The composite may display a compressive strength greater than approximately one thousand psi compressive strength after about twenty-eight days.

In another embodiment, an example of an additive combined with a type CL soil with a differentiating mineral and/or organic content, having approximately sixteen percent moisture content may comprise the following: soil about 93% to 99% by volume: additives Nano meso inorganic polymer compound, about 1%-7%, Nano meso inorganic semi solid polymer approximately 3.8 liters per cubic meter infused into soil, compressed and finished with Nano meso organic surface penetrating polymer at a rate of about 4.8 Liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent moisture content may comprise the following: soil about 82% to 95% by volume: additives Nano meso inorganic polymer compound, about 5%-18%, Nano meso inorganic semi-solid polymer approximately 2.8 liters per cubic meter infused into soil, compressed and finished with Nano meso organic surface penetrating polymer at a rate of about 5.0 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent moisture content may comprise the following: soil about 82% to 95% by volume: additives Nano meso inorganic polymer compound, about 5%-18%, Nano meso inorganic semi solid polymer approximately 3.8 liters per cubic meter infused into soil, compressed and finished with Nano meso organic surface penetrating polymer at a rate of about 5.7 liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent moisture content may comprise the following: soil about 75% to 90% by volume: additives Nano meso inorganic polymer compound, about 10%-25%, Nano meso inorganic semi solid polymer approximately 4.8 liters per cubic meter infused into soil, compressed and finished with Nano meso organic surface penetrating polymer at a rate of about 3.7 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent moisture content may comprise the following: soil about 75% to 90% by volume: additives Nano meso inorganic polymer compound, about 10%-25%, Nano meso inorganic semi solid polymer approximately 3.8 liters per cubic meter infused into soil, compressed and finished with Nano meso organic surface penetrating polymer at a rate of about 6.7 liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent moisture content may comprise the following: soil about 64% to 80% by volume: additives Nano meso inorganic polymer compound, about 20%-34%, Nano meso inorganic semi solid polymer approximately 5.5 liters per cubic meter infused into soil, compressed and finished with Nano meso organic surface penetrating polymer at a rate of about 4.3 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent moisture content may comprise the following: soil approximately 64% to 80% by volume: additives Nano meso inorganic polymer compound, approximately 20%-34%, Nano meso inorganic semi solid polymer approximately 4.5 liters per cubic meter infused into soil, compressed, and finished with Nano meso organic surface penetrating polymer at a rate of approximately 5.0 liters per 40 meters square. The composite may display a compressive strength greater than one thousand psi compressive strength after about twenty-eight days.

Another example of an additive combined with a type CL soil with a differentiating mineral and/or organic content, having approximately sixteen percent moisture content may comprise the following: soil approximately 64% to 80% by volume: additives Nano meso inorganic polymer compound, approximately 20%-34%, Nano meso inorganic semi solid polymer approximately 4.5 liters per cubic meter infused into soil, compressed, and finished with Nano meso organic surface penetrating polymer at a rate of approximately 5.0 liters per 40 meters square. The composite may display a compressive strength greater than one thousand psi compressive strength after about twenty-eight days.

Another example of an additive combined with a type CL soil with a differentiating mineral and/or organic content, having approximately sixteen percent moisture content may comprise the following: soil approximately 50% to 70% by volume: additives Nano meso inorganic polymer compound, approximately 30%-50%, Nano meso inorganic semi solid polymer approximately 6.5 liters per cubic meter infused into soil, compressed, and finished with Nano meso organic surface penetrating polymer at a rate of approximately 5.8 liters per 40 meters square. The composite may display a compressive strength greater than approximately one thousand psi compressive strength after twenty-eight days.

Another example of an additive combined with a type CH soil with a differentiating mineral and/or organic content, having approximately sixteen percent moisture content may comprise the following: soil 30% to 65% by volume: additives Nano meso inorganic polymer compound, 45%-70%, Nano meso inorganic semi solid polymer approximately 7.5 liters per cubic meter infused into soil, compressed, and finished with Nano meso organic surface penetrating polymer at a rate of 6.0 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent moisture content may comprise the following: soil 30% to 65% by volume: additives Nano meso inorganic polymer compound, 45%-70%, Nano meso inorganic semi solid polymer approximately 6.5 liters per cubic meter infused into soil, compressed, and finished with Nano meso organic surface penetrating polymer at a rate of 6.3 liters per 40 meters square. The composite may display a compressive strength greater than approximately one thousand psi compressive strength after about twenty-eight days.

Another example, all be it rare, of an additive combined with a type CH soil with a differentiating mineral and/or organic content, having approximately sixteen percent moisture content may comprise the following: soil 1% to 30% by volume: additives Nano meso inorganic polymer compound, 70%-99%, Nano meso inorganic semi solid polymer approximately 8.5 liters per cubic meter infused into soil, compressed, and finished with Nano meso organic surface penetrating polymer at a rate of 9.0 liters per 40 meters square. The composite may display a compressive strength greater than approximately one thousand psi compressive strength after about twenty-eight days.

Another example, all be it rare, of an additive combined with a type CL soil with a differentiating mineral and/or organic content, having approximately sixteen percent moisture content may comprise the following: soil 1% to 30% by volume: additives Nano meso inorganic polymer compound, 70%-99%, Nano meso inorganic semi solid polymer approximately 7.5 liters per cubic meter infused into soil, compressed, and finished with Nano meso organic surface penetrating polymer at a rate of 8.0 liters per 40 meters square. The composite may display a compressive strength greater than approximately one thousand psi compressive strength after about twenty-eight days.

Another example of an additive combined with a type CH soil with a differentiating mineral and/or organic content, having greater than sixteen percent plus four percent minimum moisture content may comprise the following: soil 93% to 99% by volume: additives Nano meso inorganic polymer compound, 1%-7%, Nano meso inorganic semi solid polymer approximately 5.8 liters per cubic meter infused into soil, compressed and finished with Nano meso organic surface penetrating polymer at a rate of 4.8 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil 93% to 99% by volume: additives Nano meso inorganic polymer compound, 1%-7%, Nano meso inorganic semi solid polymer approximately 7.0 liters per cubic meter infused into soil, compressed and finished with Nano meso organic surface penetrating polymer at a rate of 4.0 Liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent plus a minimum of four percent moisture content may comprise the following: soil 82% to 95% by volume: additives Nano meso inorganic polymer compound, 5%-18%, Nano meso inorganic semi solid polymer approximately 4.8 liters per cubic meter infused into soil, compressed and finished with Nano meso organic surface penetrating polymer at a rate of 4.5 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil 82% to 95% by volume: additives Nano meso inorganic polymer compound, 5%-18%, Nano meso inorganic semi solid polymer approximately 5.8 liters per cubic meter infused into soil, compressed and finished with Nano meso organic surface penetrating polymer at a rate of 5.9 liters per 40 meters square. The composite may display a compressive strength greater than approximately one thousand psi compressive strength after twenty-eight days.

Another example of an additive combined with a type CH soil with a differentiating mineral and/or organic content, having approximately sixteen percent plus a minimum of four percent moisture content may comprise the following: soil 75% to 90% by volume: additives Nano meso inorganic polymer compound, 10%-25%, Nano meso inorganic semi solid polymer approximately 5.8 liters per cubic meter infused into soil, compressed and finished with Nano meso organic surface penetrating polymer at a rate of 5.7 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil 75% to 90% by volume: additives Nano meso inorganic polymer compound, 10%-25%, Nano meso inorganic semi solid polymer approximately 4.5 liters per cubic meter infused into soil, compressed and finished with Nano meso organic surface penetrating polymer at a rate of 5.7 liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent plus a minimum of four percent moisture content may comprise the following: soil 64% to 80% by volume: additives Nano meso inorganic polymer compound, 20%-34%, Nano meso inorganic semi solid polymer approximately 6.5 liters per cubic meter infused into soil, compressed and finished with Nano meso organic surface penetrating polymer at a rate of 4.9 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil 64% to 80% by volume: additives Nano meso inorganic polymer compound, 20%-34%, Nano meso inorganic semi solid polymer approximately 6.5 liters per cubic meter infused into soil, compressed, and finished with Nano meso organic surface penetrating polymer at a rate of 5.8 liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent plus a minimum of four percent moisture content may comprise the following: soil 50% to 70% by volume: additives Nano meso inorganic polymer compound, 30%-50%, Nano meso inorganic semi solid polymer approximately 5.9 liters per cubic meter infused into soil, compressed, and finished with Nano meso organic surface penetrating polymer at a rate of 4.3 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil 50% to 70% by volume: additives Nano meso inorganic polymer compound, 30%-50%, Nano meso inorganic semi solid polymer approximately 6.9 liters per cubic meter infused into soil, compressed, and finished with Nano meso organic surface penetrating polymer at a rate of 6.3 liters per 40 meters square. The composite may display a compressive strength greater than approximately one thousand psi compressive strength after about twenty-eight days.

Another example of an additive combined with a type CH soil with a differentiating mineral and/or organic content, having approximately sixteen percent plus a minimum of four percent moisture content may comprise the following: soil 30% to 65% by volume: additives Nano meso inorganic polymer compound, 45%-70%, Nano meso inorganic semi solid polymer approximately 7.5 liters per cubic meter infused into soil, compressed, and finished with Nano meso organic surface penetrating polymer at a rate of 6.0 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil about 30% to 65% by volume: additives Nano meso inorganic polymer compound, about 45%-70%, Nano meso inorganic semi solid polymer approximately 6.8 liters per cubic meter infused into soil, compressed, and finished with Nano meso organic surface penetrating polymer at a rate of about 6.1 liters per 40 meters square. The composite may display a compressive strength greater than approximately one thousand psi compressive strength after about twenty-eight days.

Another example, all be it rare, of an additive combined with a type CH soil with a differentiating mineral and/or organic content, having approximately sixteen percent plus a minimum of four percent moisture content may comprise the following: soil about 1% to 30% by volume: additives Nano meso inorganic polymer compound, about 70%-99%, Nano meso inorganic semi solid polymer approximately 8.7 liters per cubic meter infused into soil, compressed, and finished with Nano meso organic surface penetrating polymer at a rate of about 8.8 liters per 40 meters square. The composite may display a compressive strength greater than approximately one thousand psi compressive strength after about twenty-eight days.

Another example of an additive combined with a type CL soil with a differentiating mineral and/or organic content, having approximately sixteen percent plus a minimum of four percent moisture content may comprise the following: soil about 1% to 30% by volume: additives Nano meso inorganic polymer compound, about 70%-99%, Nano meso inorganic semi solid polymer approximately 8.5 liters per cubic meter infused into soil, compressed, and finished with Nano meso organic surface penetrating polymer at a rate of about 8.1 liters per 40 meters square. The composite may display a compressive strength greater than approximately one thousand psi compressive strength after about twenty-eight days.

Geopolymers may include but not limited to ground granite, fly ash, and lime. Lime may be made from ground limestone rock, which naturally contains calcium carbonate and magnesium carbonate. Lime may be added to soil, to increase the soil's pH, making the soil less acidic and more alkaline. Lime-cement may be used as a stabilizing binder to treat the soil. For example, strength or stabilizing characteristics. These mixes/additives maintain no sustainable anti leaching qualities without being paired with the primary nano composite compounds described, for example, in paragraphs [00112]-[00139].

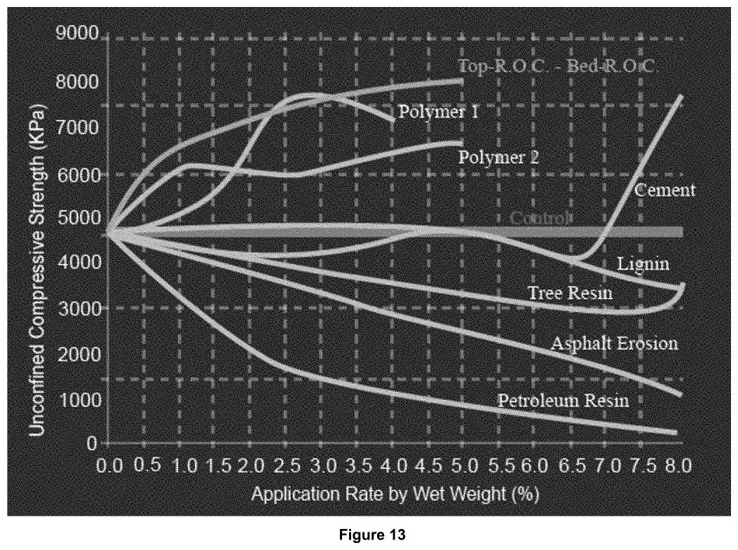

FIG. 13 shows CBR results dry soils, in accordance with an embodiment of the present invention, comparing many stabilization materials to Polymer 1 (NanoCrete), Polymer 2 (XWCrete) and compound NanoCrete with BedR.O.C. and TopR.O.C. Note: cement not mixed with soil curing as a control.

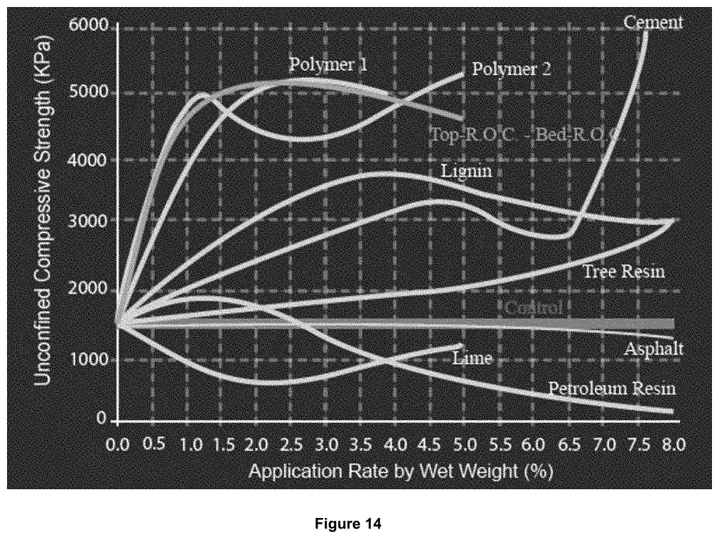

FIG. 14 shows CBR results, in accordance with an embodiment of the present invention, comparing many stabilization materials to Polymer 1 (NanoCrete), Polymer 2 (XWCrete) and compound XWCrete with BedR.O.C. and TopR.O.C. Note: cement not mixed with soil curing as a control.

FIG. 15 shows an illustration of a Leaching test/soil tailings analysis, in accordance with an embodiment of the present invention. The environmental performance evaluation was determined by the Leaching test, conducted by the University of Arizona, on the Soil-Mine Tailings sample with the Nano meso inorganic polymer additives, in accordance with an embodiment of the present invention, to determine the capability of the binder in retaining heavy metals. The results of the leaching test show that the binder was able to reduce the heavy metals in the leachate below the regulatory level, with the exception of mercury (not yet tested). Mineralogical analysis done on the leached samples revealed that the binder was able to immobilize the mine tailing minerals that could adversely affect the environment in the soil matrix.

The CBR and Atterberg limits comparing Nano meso inorganic polymer, Portland cement, other geopolymers and other stabilizers results. The final result with Nano inorganic polymer as hydrophobic may translate to-no water in no acid formed, no acid formed no break down, no break down no leachates, no water in little to no osmotic leach possible. Whereas the Portland cement and the geopolymer both absorbed water and increased and promoted leaching. The CBR values of the nano meso inorganic polymer translated into KPa far exceed all other earthen travel base stabilizers and/or stabilization materials, see USACE graphs attached.

Another example of an additive combined with a soil having greater than approximately sixteen percent moisture content comprises the following: XWCrete, BedR.O.C, TopR.O.C. and include fly ash and lime. The additive may comprise between two and twenty weight percent, or between one and fifty volume percent of the composite formed by the additive and soil. The composite displays a compressive strength greater than about one thousand psi after twenty-eight days and contains mine tailings leachates.

Another example of an additive combined with a soil having greater than approximately sixteen percent moisture content comprises the following: XXWCrete, BedRoc, TopRoc, portland cement fly ash, and lime. The additive comprises between two and twenty weight percent, or between five and fifty volume percent, of the composite formed by the additive and soil. The composite displays a compressive strength greater than approximately one thousand psi after about twenty-eight days and may contain mine tailings leachates.

Another example of an additive combined with a soil having greater than approximately sixteen percent moisture content comprises the following: XXWCrete, BedRoc, TopRoc, portland cement, and lime. The additive may comprise between two and twenty weight percent, or between five and fifty volume percent of the composite formed by the additive and soil. The composite displays a compressive strength greater than about one thousand psi after twenty-eight days and contains mine tailings leachates.

Another example of an additive combined with a soil having greater than approximately sixteen percent moisture content comprises the following: XXWCrete, BedRoc, and lime. The additive may comprise between two and twenty-five weight percent, or between five and fifty volume percent of the composite formed by the additive and soil. The composite displays a compressive strength greater than approximately eight hundred psi after about twenty-eight days and contains mine tailings leachates.

As will be appreciated by one skilled in the art, the examples of additives combined with soil above may be generalizations of the weight or volume percentages needed depending on the percent moisture content of the soil, leachate content of the soil, and the actual weight or volume percentages may fall outside of the listed ranges.

Additional features of embodiments as highlighted herein may include binding and containment of potential leachates, greater structural integrity and stability, dust and mud control, ion realignment resulting in hydrophobic properties, binding of prospective leachates including hazardous and toxic substances such as the RCRA 8 metals, hydrophobic properties that disallow osmotic migration of hazardous or toxic leachates, a novel combination of toxic material containment, structural stabilization, and ability to be molded to desired shape. The particle size of the inorganic powders and semisolids, combined in nano scale, may create greater surface area for reactivity, thus the isomers may have far more reactivity potential. In part, this reactivity potential may create many more stereoisomers forming meso compounds and ligands by three characteristics—ionic reactive formations, coordinated formations, and linked formations. These are the foundation of the novel properties peculiar to scaled nano meso inorganic polymerization.

In one embodiment, the system may lock toxic leachates into the applied toxic tailings mass, such that the tailings cannot leach out to the ground or ground water, or dust out to air, while having the ability to remediate fracking soils, fly ash and other varieties of soils with contaminant issues. In addition, the system is anionic. When the system is applied to the toxic tailings mass, water may not penetrate/infiltrate into, erode, or break down the soil mass. This characteristic may substantially block potential osmotic leaching. Additionally, the system applied to the toxic tailings may create structural stability increasing the structural values of the mass it is applied to, this characteristic may help to reduce liquifaxing or flow of soils mass. Further, the system may incorporate Nano technology particles, depending on the chemical make-up of the toxic tailings mass. The compressive strength of the tailings mass may significantly increase based upon a percent of system to volume of toxic tailings. The system may not contain V.O.Cs (volatile organic compounds). The system is environmentally friendly and compatible leaving and environment positive impact replacing an initial environment negative impact of the target soils. Moreover, the system may stop toxic tailings from leaching toxins. Leachates are well under acceptable RCRA 8 EPA limits for seven of the eight RCRA metals, substantially reduces liquifaxing (mud slides), significantly reduces structural shift of toxic tailings, stops permeation of water into toxic tailings, stopping breakdown of toxic tailings, and greatly reduces dusting of toxic tailings or transfer by mud of toxic tailings. This again is in part due to the particle size of the inorganic powders and semisolids, combined in nano scale, may create greater surface area for reactivity, thus the isomers may have far more reactivity potential. In part, this reactivity potential may create many more stereoisomers forming meso compounds. Ligands by three characteristics may include ionic reactive formations, coordinated formations, and linked formations. These are the foundation of the Novel Properties peculiar to scaled Nano meso inorganic polymerization (See FIGS. 1-3 and 6-10).

In some embodiment, a process for using the system described above may begin with wetting the tailings up to a predetermined percent moisture content i.e. <16% moisture content. An inorganic powder such as but not limited to Pro-SealECCO powder, Portland cement, lime, fly ash, talc, silica, etc. may be spread based on a determined percentage of toxic tailings mass or fracking soils mass required to achieve stabilization and containment. Percent to volume or percent to weights will vary based upon soil type, moisture content, chemical makeup and regional or geological climatic characteristics seasonal changes of a certain soil, its location, and other potential effecting operations or activities at or near such a target site. A vitriform polymer, such as Pro-SealECCO, may be introduced as the Pro-SealECCO powder is infused into the contaminated soil based upon mass and toxic content. As described, vitriform may be a semi-liquid that may change from solid to liquid or liquid to solid with a change in temperature. The treated mass may then be compressed under a determined load. A top sealer such as but not limited to Pro-SealECCO TopR.O.C., Acrylics, urethanes, polysulfides, alkyds, methyl methacrylate, by Dow, Dow corning, Carlyle, PoSoCo and other, top sealer, may then be sprayed onto the treated mass at a predetermined rate based upon mass and toxic content, i.e. but not limited to, 1 gal: 100 feet², 1 gal:500 feet², etc., of soil surface area and the treated mass may be further compressed to a predetermined load. For example, the treated mass is then compressed and/or vibrated for compaction and may be molded or formed to a predetermined shape based upon purpose and use or future intended use of the treated mass i.e. but not limited to, berms, mounds, ponds, bricks, pellets, etc.

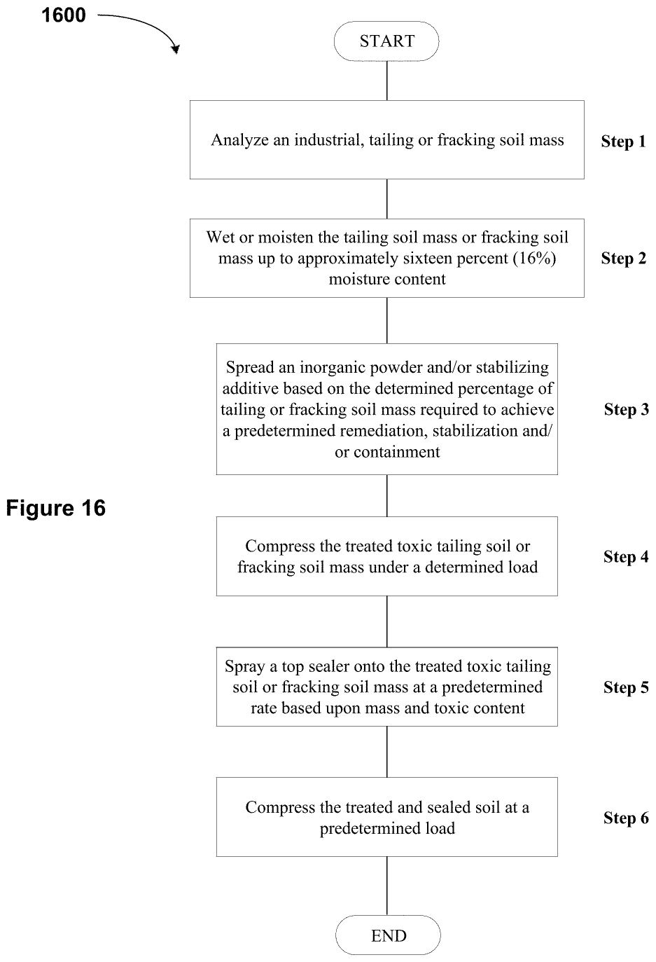

FIG. 16 illustrates a flowchart detailing an exemplary method 1600 of remediating or stabilizing industrial, tailing or fracking soil, in accordance with an embodiment of the present invention. In the present embodiment, the process for remediating tailings soil may begin with a Step 1: An industrial, tailing or fracking soil mass sample may be analyzed. This analysis may include but is not limited to soil type, climatic condition of site, soil moisture content, soil particle size, toxins in soil and percent, organics in soil and percent Atterberg limits of soil, absorptive properties of soil, plasticity of soil, shrinkage potential of soil, etc.

In a Step 2: Wetting or moistening the industrial, tailing, or fracking soil mass to a predetermined percent moisture content based on the results of the analyzed tailing soil sample. Examples of industrial and/or tailing soil mass may include soils associated with tailings from industrial operations such as mining or smelting, cement manufacturers, fly ash, silicate manufacturers, dirty power i.e. coal power, landfill, water based polymer manufacturers, contaminated retention ponds and related semi-solid and saturated and contaminated sediments, silts, sludge, fracking waste and runoff, brownfields, construction sites, railroad beds, road beds, waste water evaporation ponds, reservoir bases, slope slide control, storm drain control and canals, gardening, garden paths, park trails, etc.

In a Step 3: An inorganic powder may be spread based on the determined percentage of tailing soil mass or fracking soil mass to achieve a predetermined remediation, stabilization and/or containment. A vitriform polymer may be introduced as the powder is infused into the toxic tailing soil or fracking soil based upon the mass and toxic content of the soil. As described, vitriform may be a semi-liquid that may change from solid to liquid or liquid to solid with a change in temperature.

In a Step 4: The treated toxic tailing soil or fracking soil mass may then be acompressed under a determined load.

In a Step 5: A top sealer may then be sprayed onto the treated and compressed toxic tailing soil or fracking soil mass at a predetermined rate based upon mass and toxic content.

In a Step 6: The sealed, treated and compressed toxic tailing soil or fracking soil mass may be further compressed at a predetermined load. For example, the sealed, treated and compressed mass is then further compressed and/or vibrated for compaction and may be molded, formed or otherwise shaped based upon purpose and use or future intended use of the treated mass.

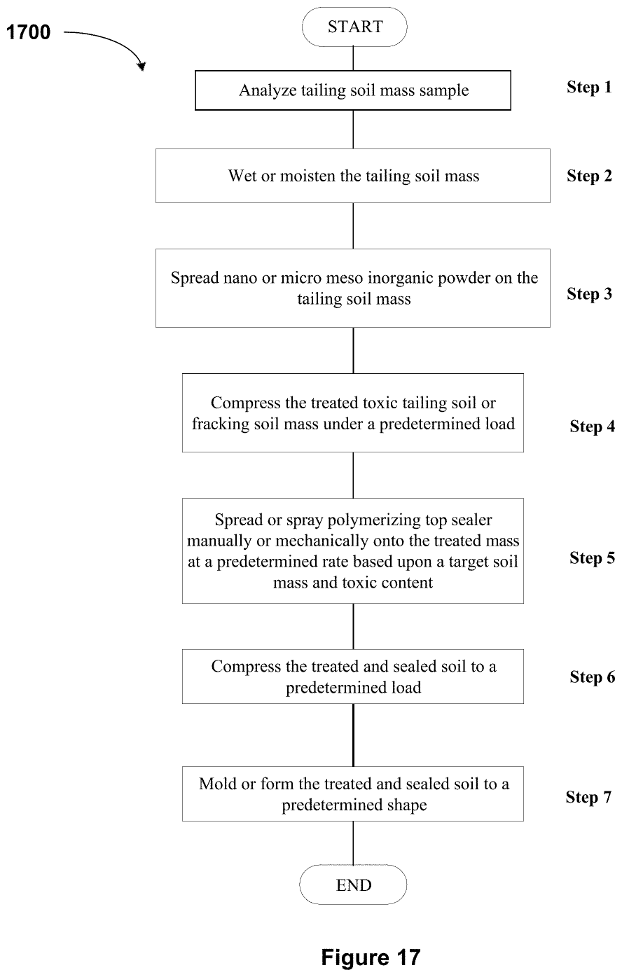

FIG. 17 illustrates a flowchart detailing another exemplary method 1700 of remediating or stabilizing, but not limited to, tailing or fracking soil, in accordance with an embodiment of the present invention. In the present embodiment, the process for remediating or stabilizing of a tailing soil mass may begin with a Step 1: analyze the tailing or fracking soil sample. This analysis may include but is not limited to soil type, climatic condition of the site, soil moisture content, soil particle size, toxins in the soil and percent, organics in soil and percent, Atterberg limits of soil, absorptive properties of soil, plasticity of soil shrinkage potential of soil, etc.

In a Step 2: the tailings or fracking soil mass may be wetted or moistened with water to a predetermined minimum percentage of moisture content.

In a Step 3: an inorganic polymer in powder form, such as but not limited to a nano or micro meso, may be spread manually or mechanically at a predetermined percent to the tailings soil mass to achieve stabilization and containment. The Nano meso inorganic vitriform polymer may be introduced as the meso inorganic powder is infused manually or mechanically tilled or reclaimed into the target soils in situ, based upon the mass and toxic content of the soil.

In a Step 4: the treated tailing soil mass may then be compressed under a predetermined load.

In a Step 5: the polymerizing top sealer may then be manually or mechanically spread or sprayed onto the treated mass at a predetermined rate based upon a target soil mass and toxic content.

In a Step 6: the treated and sealed soil mass is further compressed and/or vibrated for compaction to a predetermined load.

In a Step 7: the treated and sealed soil mass may be molded or formed to a predetermined shaped based upon purpose, use or future intended use of the treated and sealed soil mass. The treated and sealed soil mass generally binds in seven of the RCRA eight metals (less one untested (Hg)). The RCRA 8 metals are metals may include Ag (silver), As (arsenic), Ba (barium), Cd (cadmium), Cr (chromium), Hg (mercury), Pb (lead), and Se (selenium). The treatment and sealing process may bind other known toxic materials to target soils and may structurally stabilize known soils and fly ashes. The treated and sealed soil mass is hydrophobic and anionic, stops erosion from weather, stops or controls mud and dust, stabilizes under and behaves as secondary containment under containment and other earthen pond or basin liner materials, stabilizes earthen dams, berms, spillways, canals, trenches, lakes, drainage ditches, hill sides, slopes, drill platform pads, parking pads, construction pads, road bases, roads, utility access roads, paths, trails, commercial and residential, etc.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

In relatively simple practical applications, for example, without limitation, may require only NanoCrete and/or XXW BedROC with BedROC or similar materials at a one to two percent additive to weight of target soils with moisture to achieve performance characteristics. In some more extreme cases, there may be a requirement of NanoCrete and/or XXW with BedROC or similar materials at up to greater than eighty percent additive to weight of target soils with moisture to achieve performance characteristics. In some rare cases only NanoCrete or XXXWCrete jointly or severally may be required at any variety of percent to weight or volume as dictated by the target soil. Further in even more rare cases BedROC may be solely required as dictated by the target soils.

As will be appreciated by one skilled in the art, other applications may include, without limitation, stabilization and containment of oil brown fields, marine harbor lands and landings, coal power waste fly ash management, waste management, nuclear waste management, road bases, access roads, utility roads, garden paths, forest service paths, hill side slide control, leaching basins, evaporation basins or ponds, containment basins or ponds, water management, dust management, irrigation canals and irrigation trenches, flood control and canals, locks and dams, walking paths, parks and recreations, zoos, botanical gardens and any of a variety of other earthen structural uses.

Some of the foregoing steps may be optional depending on the specific needs of each scenario. For example, without limitation, TOPROC or equivalent may or may not be used in every lift. Additionally, NanoCrete and XXXWCrete may be used together or severally. These uses and applications may be project characteristic dependent and may be determined on a per project basis.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing soil stabilization according to the present invention will be apparent to those skilled in the art. Various aspects of the invention have been described above by way of illustration, and the specific embodiments disclosed are not intended to limit the invention to the particular forms disclosed. The particular implementation of the soil stabilization may vary depending upon the particular context or application. By way of example, and not limitation, the soil stabilizations described in the foregoing were principally directed to stabilization additive implementations; however, similar techniques may instead be applied to any materials, as defined most broadly as soils herein, where stabilization would be advantageous, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to, the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. A method of remediating an industrial, tailings, and fracking soil mass comprising the steps of:
analyzing a sample of at least one of the industrial, tailings, and fracking soil mass, in which the industrial and/or tailing soil mass comprises soils associated with tailings from industrial operations including mining or smelting, cement manufacturing, silicate manufacturing, coal power, landfill, water-based polymer manufacturers, contaminated retention ponds or contaminated sediments, silts, sludge, fracking waste and runoffs;
wetting or moistening a predetermined volume of at least one of the industrial, tailings, and fracking soil mass sample with water to a predetermined minimum percentage of moisture content;
spreading or treating with a nano or micro meso inorganic polymer and a stabilizing additive the predetermined volume of at least one of the moistened industrial, tailings, and fracking soil mass sample for stabilization and containment;
compressing at least one of the treated predetermined volume of industrial, tailings, and fracking soil mass sample under a predetermined load;
spreading or spraying a top sealer onto at least one of the compressed and treated predetermined volume of industrial, tailing, and fracking soil mass sample at a predetermined rate based upon a predetermined soil mass and toxic content; and
compressing or vibrating at least one of the sealed, compressed, and treated predetermined volume of industrial, tailing, and fracking soil mass.

2. The method of claim 1, further comprising the steps of molding or forming at least one of the sealed, compressed, and treated predetermined volume of industrial soil, mine soil tailing, and fracking soil mass to a predetermined shape.

3. The method of claim 2, in which said top sealer comprises a polymerizing top sealer including a Pro-SealECCO TopR.O.C. material.

4. The method of claim 2, in which said meso inorganic polymer comprises a nano or micro meso inorganic polymer composition.

5. The method of claim 2, in which said predetermined minimum percentage of moisture content comprises approximately sixteen percent (16%) moisture content.

6. The method of claim 5, in which said stabilizing additive comprises at least a lime material made from ground limestone rock.

7. The method of claim 6, in which said stabilizing additive further comprises kiln dust.

8. The method of claim 7, in which said stabilizing additive including said nano or micro meso inorganic polymer, kiln dust, and lime comprises between two and twenty weight percent of the composite formed by the stabilizing additive and at least one of the sealed, compressed, and treated predetermined volume of industrial soil, mine soil tailing, and fracking soil mass sample.

9. The method of claim 6, in which said stabilizing additive further comprises fly ash.

10. The method of claim 9, in which said stabilizing additive including said nano or micro meso inorganic polymer, fly ash, and lime comprises between five and fifty volume percent of the composite formed by the stabilizing additive and at least one of the treated, compressed, and molded industrial soil, mine soil tailing, and fracking soil mass sample.

11. The method of claim 10, in which said composite comprises a compressive strength greater than one thousand PSI after twenty-eight (28) days.

12. The method of claim 10, in which said composite is configured to be operable for stopping toxic tailings from leaching toxins.

13. The method of claim 12, in which said composite is further configured to reduce liquifaxing and reduce structural shift of toxic tailings.

14. The method of claim 13, in which said stabilizing additive further comprises one or more anionic materials and in which said composite is further configured to stop permeation of water into toxic tailings.

15. The method of claim 14, in which said stabilizing additive further comprises one or more barrier components and in which said composite is further configured to stop breakdown of toxic tailings.

16. The method of claim 15, in which said stabilizing additive comprises talc and silica spread to at least one of the moistened industrial soil, mine soil tailing, and fracking soil mass sample.

17. The method of claim 16, in which said talc and silica spread is based on a determined percentage of toxic soil, tailings, or fracking soil mass required to achieve stabilization and containment.

18. The method of claim 7, in which said stabilizing additive comprises a vitriform polymer.

19. A method of remediating an industrial, tailing, or fracking soil mass comprising the steps of:
analyzing a sample of the industrial, tailing, or fracking soil mass, in which the industrial and/or tailing soil mass comprises soils associated with tailings from industrial operations including mining or smelting, cement manufacturing, silicate manufacturing, coal power, landfill, water-based polymer manufacturers, contaminated retention ponds or contaminated sediments, silts, sludge, fracking waste and runoffs;
wetting or moistening a predetermined volume of the industrial soil, mine soil tailing, or fracking soil mass with water to a predetermined minimum percentage of moisture content, in which said predetermined minimum percentage of moisture content comprises approximately sixteen percent moisture content;
means for stabilizing the predetermined volume of moistened industrial soil, mine soil tailings, or fracking soil mass;
compressing the predetermined volume of moistened stabilized industrial soil, mine soil tailing or fracking soil mass under a predetermined load;
means for sealing the stabilized predetermined volume of moistened and compressed industrial soil, mine soil tailing or fracking soil mass at a predetermined rate based upon a target soil mass and toxic content; and
compressing by vibrating said sealed predetermined volume of moistened and compressed industrial soil, mine soil tailing or fracking soil mass for compaction to a predetermined load.

20. A method of remediating a tailing or fracking soil mass comprising the steps of:
analyzing a sample of the tailing and fracking soil mass, in which the tailing soil mass comprises soils associated with tailings from industrial operations including mining or smelting, cement manufacturing, silicate manufacturing, coal power, landfill, water-based polymer manufacturers, contaminated retention ponds or contaminated sediments, silts, sludge, fracking waste and runoffs;
wetting or moistening a predetermined volume of the tailing or fracking soil mass with water to a predetermined minimum percentage of moisture content;
spreading a stabilizing additive to the predetermined volume of tailings or fracking soil mass, in which said stabilizing additive comprises at least a fly ash or kiln dust, lime, miso organic nano barrier additive, and nano or micro meso inorganic binder additive;
compressing the predetermined volume of stabilized tailing or fracking soil mass under a predetermined load;
spreading or spraying a polymerizing top sealer onto the predetermined volume of stabilized tailing or fracking soil mass at a predetermined rate based upon a target soil mass and toxic content;
compressing or vibrating said sealed predetermined volume of stabilized tailing or fracking soil mass for compaction to a predetermined load; and
molding or forming said sealed and compressed predetermined volume of stabilized tailing or fracking soil mass to a predetermined shape.
